(19) United States
(12) Patent Application Publication
(10) Pub. No.: US 2007/0294898 A1
(43) Pub. Date: Dec. 27, 2007

(54) Rotating food-processing knife with detachable multi blade axis

(76) Inventor: Roberto Beltran, Mexicali (MX)

Correspondence Address: Roberto Beltran Varela, 1002 Skyview, El Centro, CA, 92243, US

(21) Appl. No.: 11/475,616

(22) Filed: Jun. 27, 2006

(51) Int. Cl. B26B 3/00

(52) U.S. Cl. 30/307

(57) ABSTRACT

A specialty food-processing knife includes a rigid handle, a circular blade axis, a blade axis holder, a blade axis holder lock, and a blade axis safety cover. The handle provides a blade axis upper housing to cut protect the user's hand and is configured with guide grooves, coupling pivot holes, and a guide tunnel. The guide grooves restrict the blade axis movement to a circular motion, the pivot holes allow swiveling of the blade axis holder, and the guide tunnel provides unidirectional motion to the blade axis holder lock. The blade axis is composed of several parallel circular blades, which are held in position by spacer bushings and lock nuts that encapsulate a stiffener rod. The blade axis holder presents a parallel slotted array to prevent food fragments from entering the blade axis housing and allow the axis blades to be partially exposed and rotate freely. The blade axis holder lock includes barriers, which limit the lock to an open or closed position. The blade axis cover has a locating lip that allows coupling with the knife handle.

### BACKGROUND OF THE INVENTION

1. Field of the Invention

The present invention relates to food processing knifes, and more particularly to a food processing knife with parallel rotating circular blades.

2. Description of Related Art

When cooking courses, there are some meals that are served on the spot and require hot of the grill meat which must be slit or chopped for course preparation therefore, the cutting operation must be performed at a fast pace to prevent the grilled meat from getting cold and be able to serve several meals simultaneously. Generally, this cutting action is carried out by employing single bladed knives which require great effort to continuously process large meat quantities in a short time period thus quickly fatiguing the user and presenting an unnecessary burden that is tiring, unpleasant and time consuming.

Fixed blade knives with a single straight blade attached to a wood or plastic handle by means of glue or rivets are commonly used to slit or chop grilled meats, vegetables, and other types of foodstuffs. Diverse inventions have been developed to alleviate special cutting inconveniences including U.S. Pat. No. 247,603, U.S. Pat. No. D450,224, U.S. Pat. No. 342,000 and U.S. Pat No. 362,006.

A typical approach is illustrated by the invention of U.S. Pat. No. D450,224 which discloses a rectangular chopping board and knife combination in which the knife blade end opposite to the knife handle is permanently attached by a swivel joint to the chopping board. Another design can be found on U.S. Pat. No. 247,603 which discloses a combined circular chopping block and knife. These knife combinations present a single straight blade knife, which precludes the user from performing two or more cuts with a single stroke. Therefore, in the case of a user who must slit or chop large quantities of hot of the grill meat in a short time period, the use of such knife and chop board combination presents an inconvenience.

The invention of U.S. Pat. No. 342,000 includes a multi bladed knife design in which three straight parallel blades are permanently attached at one of their ends to a single handle. This multi bladed knife has the advantage of performing three simultaneous cuts with a single stroke. This same artifact presents an inefficient cutting force transfer due to the handle position with respect to the blades thus increasing the required force magnitude the user must supply to the knife to achieve a successful operation. This excessive required operating force prematurely fatigues and strains the user's wrist and precludes him from performing a continuous fast operation. Further more, this multi bladed knife requires use of another utensil such as a fork to get hold of the grilled meat to be slit or chopped and permit the cutting action.

Another approach to alleviate special cutting inconveniences can be found in U.S. Pat. No. 362,006 which discloses a combined circular knife and guard. The guard is fastened to a rectangular handle by means of a socket head cap screw, which serves as a pivot point to swivel the guard and expose or protect the circular blade. The circular blade is located at one of the handle ends and is fastened at its center with a socket head cap screw, which allows it to rotate freely on an axis perpendicular to the handle orientation. This design has the advantage of having a circular blade thus facilitating the cutting action in comparison to a single straight blade knife. This circular knife also portrays the disadvantages of limiting the user to perform a single cut per stroke and an inefficient cutting force transfer from the user's hand to the blade due to the blade position with respect to the handle which is a common characteristic of food processing knifes.

### SUMMARY OF THE INVENTION

Considering the above problems of existing designs, the object of the present invention is to provide a food processing knife with the capability to slit or chop large amounts of hot of the grill meat and other food stuffs in a rapid and effortless manner. This artifact must enable the user to perform simultaneous cuts per stroke, eliminate the need for an extra utensil such as a fork to hold the meat when processing and maximize force transfer to decrease premature user fatigue and unnecessary burden.

In order to achieve the stated design objective the present invention has a closed loop rigid handle with integrated blade axis housing, protective guards, and assembly provisions for a rotating multi circular blade axis, a swiveling blade axis holder, a blade axis holder lock and a blade axis safety cover. The handle is geometrically fitted such that the user's hand grip point is located right over the blade rotating axis thus forming a full vertical force transfer plane between the user's hand and blade axis. This configuration maximizes force transfer efficiency and consequently decreases the required down force (vertical component) to cut into the meat thus diminishing premature user fatigue.

The blade axis is composed of equidistant circular blades configured in a parallel array along a symmetry axis. The blades are held in place by spacer bushings that are compressed by locking nuts located at opposite ends. The locking nuts and spacer bushings encapsulate a stiffener rod which prevents the blade axis assembly to flex beyond a given design distance when a maximum operating force is applied to it. This multi bladed configuration enables the user to perform simultaneous cuts per stroke thus decreasing processing time.

When the blade axis is locked in place it is allowed to freely rotate clockwise or counterclockwise on an axis perpendicular to the cut direction. This particular characteristic permits the user to cut into the meat with a forward and backward motion and since the blade shape is circular the contact section per blade is smaller than conventional straight blades therefore permitting easier blade penetration and eliminating the need for a utensil to prevent grilled meat sliding over the chopping board.

When slit meat is desired the knife is rolled back and forth with a small increase in the motion direction angle. If chopped meat is preferred the same forward and backward motion is employed with greater angle change in motion direction. This generates multidirectional simultaneous cuts thus chopping the grilled meat rapidly.

The combination of the above characteristics allows the user to easily process hot of the grill meat in and effortless and rapid manner without suffering from premature fatigue. This allows for several warm meal preparations in a short time period and permits the user to process large meat quantities without the tiring and unpleasant burden associated with such activity when other artifacts are employed.

Additional aspects of the invention, together with the advantages and novel features appurtenant thereto, will be set forth in part in the description which follows, and in part will become apparent to those skilled in the art upon examination of the following, or may be learned from the practice of the invention. The objects and advantages of the invention may be realized and attained by means of the instrumentalities and combinations particularly pointed out in the appended claims.

### BRIEF DESCRIPTION OF THE DRAWINGS

FIG. 1 is perspective view of a preferred embodiment of a rotary food processing knife in accordance with the invention in a first disposition;

FIG. 2 is a perspective view of the preferred embodiment of a rotary food processing knife in accordance with the invention shown in FIG. 1 in a second disposition;

FIG. 3 is a perspective view of the preferred embodiment of a rotary food processing knife in accordance with the invention shown in FIG. 1 in a third disposition;

FIG. 4 is a perspective view of the preferred embodiment of a rotary food processing knife in accordance with the invention shown in FIG. 1 in a fourth disposition;

FIG. 5 is a perspective view of the preferred embodiment of a rotary food processing knife in accordance with the invention shown in FIG. 1 in a fifth disposition;

FIG. 6 is a left side view of the preferred embodiment of a rotary food processing knife in accordance with the invention shown in FIG. 1 in a first disposition;

FIG. 7 is a left side view of the preferred embodiment of a rotary food processing knife in accordance with the invention shown in FIG. 1 in a second disposition;

FIG. 8 is a left side view of the preferred embodiment of a rotary food processing knife in accordance with the invention shown in FIG. 1 in a third disposition;

FIG. 9 is a left side view of the preferred embodiment of a rotary food processing knife in accordance with the invention shown in FIG. 1 in a fourth disposition;

FIG. 10 is a front view of the preferred embodiment of a rotary food processing knife in accordance with the invention shown in FIG. 1 in a first disposition;

FIG. 11 is a front view of the preferred embodiment of a rotary food processing knife in accordance with the invention shown in FIG. 1 in a second disposition;

FIG. 12 is a sectional view of a portion of the preferred embodiment of a rotary food processing knife in accordance with the invention shown in FIG. 11 in a first disposition;

FIG. 13 is a left side view of a portion of the preferred embodiment of a rotary food processing knife in accordance with the invention shown in FIG. 1 in a first disposition;

FIG. 14 is a plant view of a portion of the preferred embodiment of a rotary food processing knife in accordance with the invention shown in FIG. 1 in a first disposition;

FIG. 15 is a perspective view of a portion of the preferred embodiment of a rotary food processing knife in accordance with the invention shown in FIG. 1 in a first disposition;

FIG. 16 is a perspective view of a portion of the preferred embodiment of a rotary food processing knife in accordance with the invention shown in FIG. 1 in a second disposition;

FIG. 17 is a perspective view of a portion of the preferred embodiment of a rotary food processing knife in accordance with the invention shown in FIG. 1 in a third disposition;

FIG. 18 is a perspective view of a portion of the preferred embodiment of a rotary food processing knife in accordance with the invention shown in FIG. 1 in a fourth disposition;

FIG. 19 is a perspective view of a portion of the preferred embodiment of a rotary food processing knife in accordance with the invention shown in FIG. 1 in a fifth disposition.

### DETAILED DESCRIPTION OF PREFERRED EMBODIMENTS

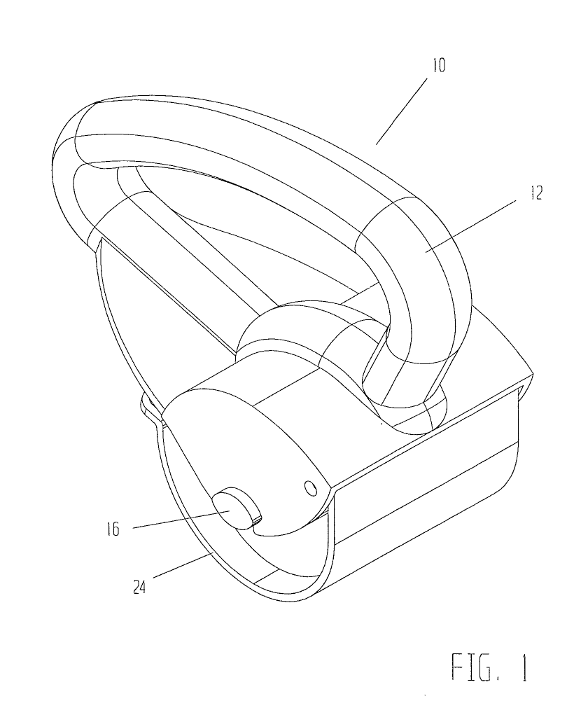

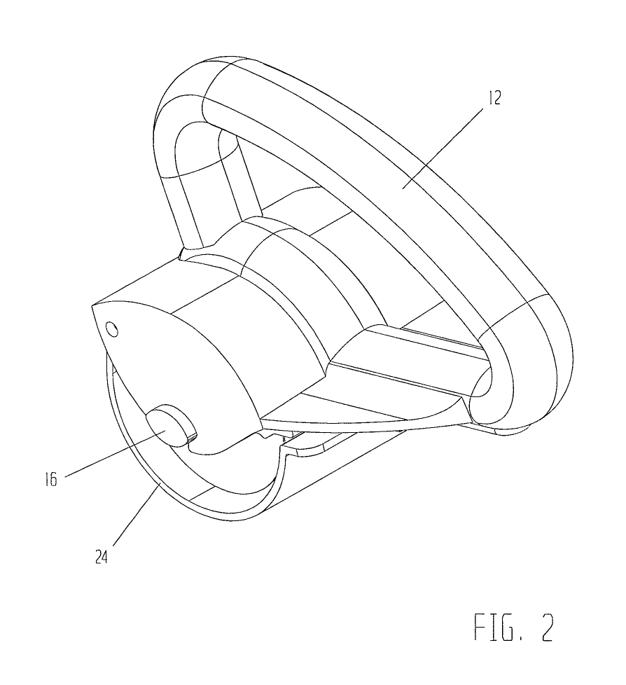

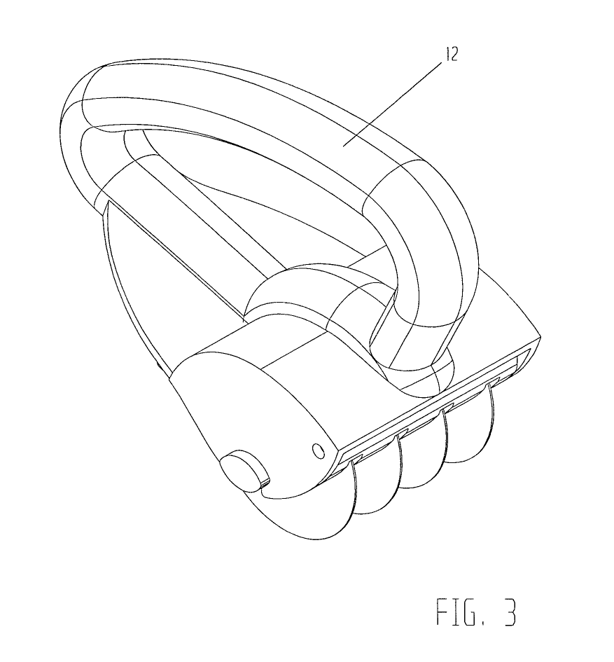

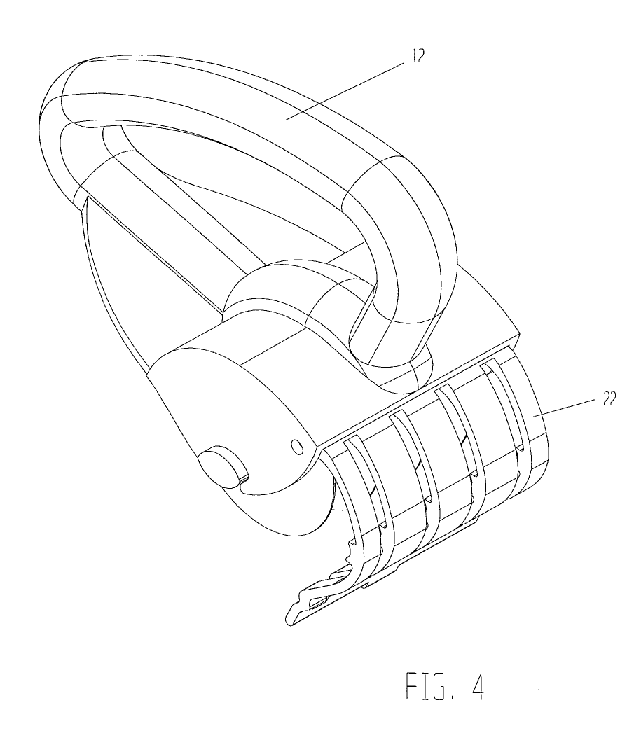

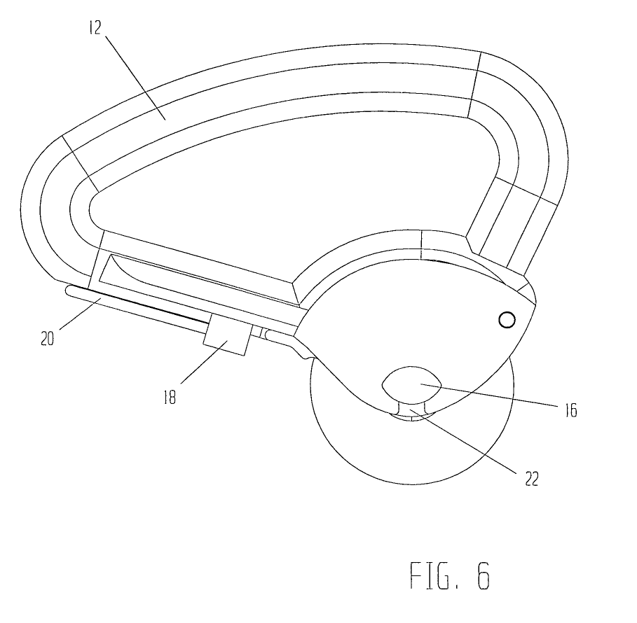

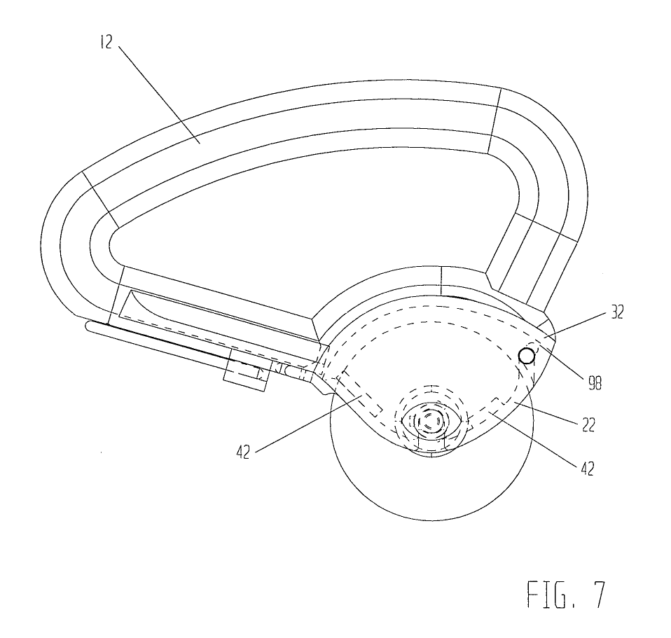

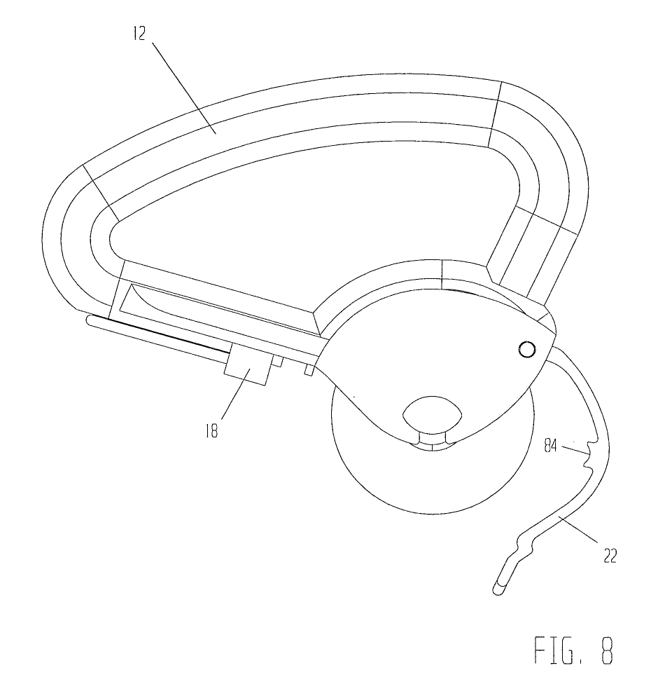

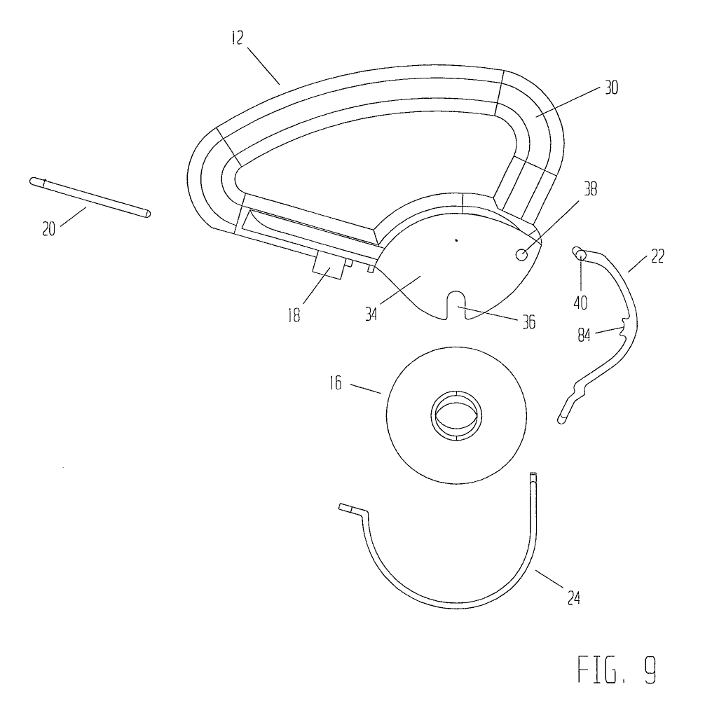

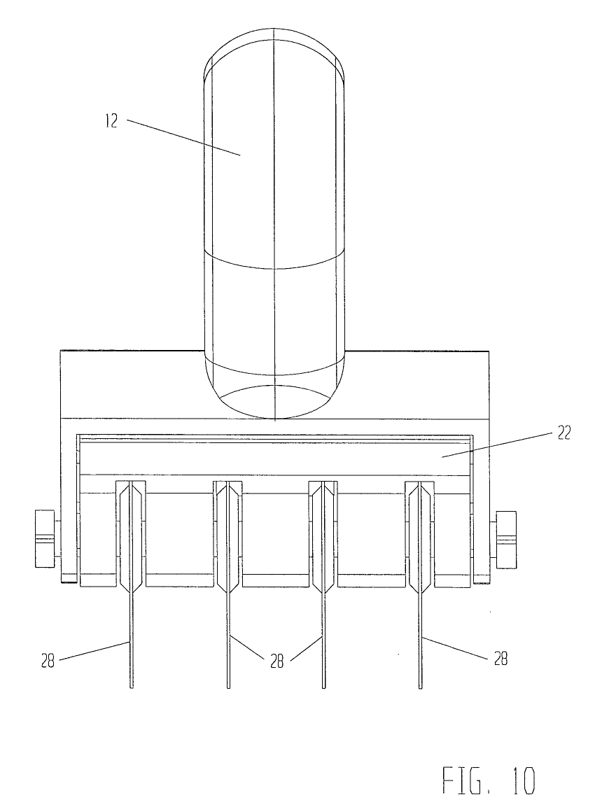

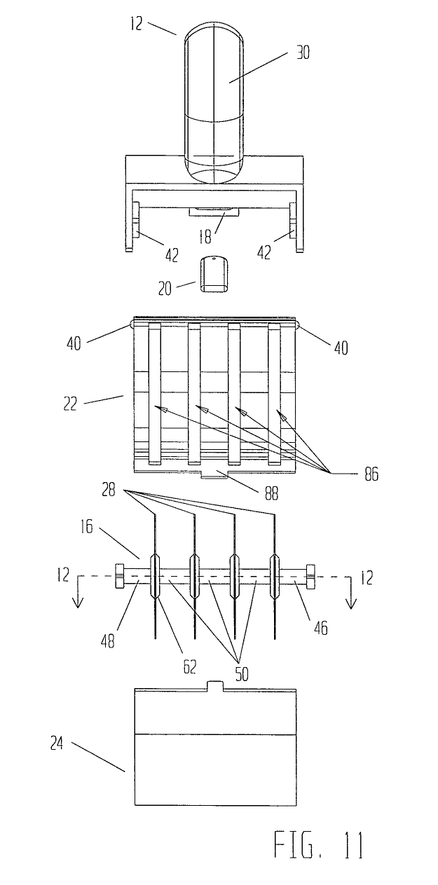

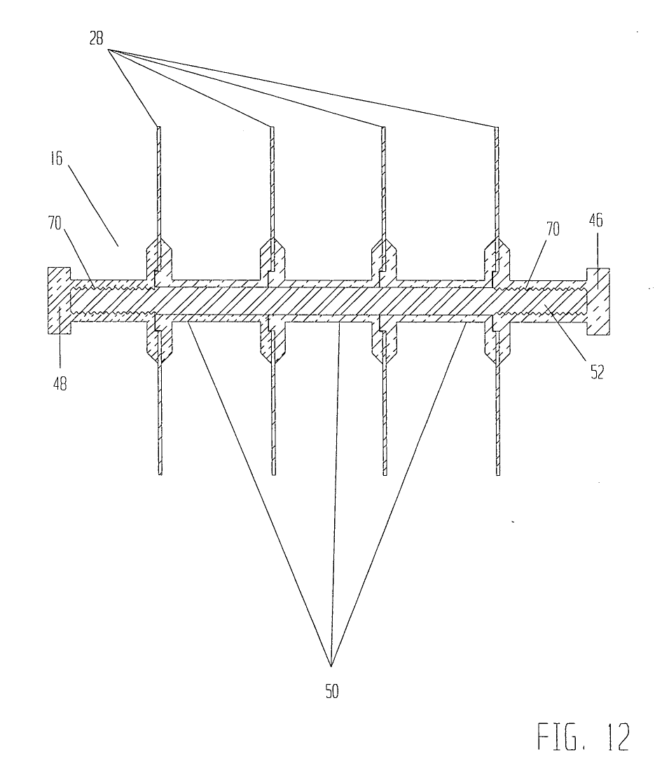

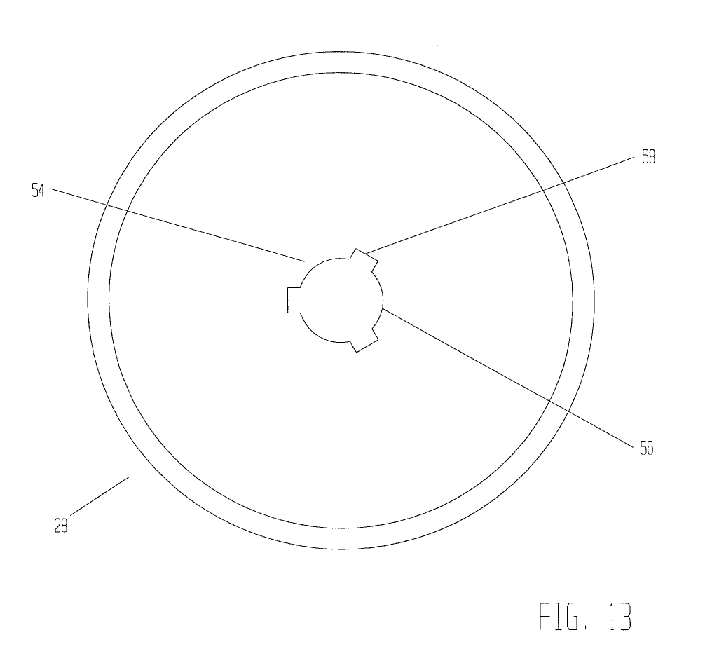

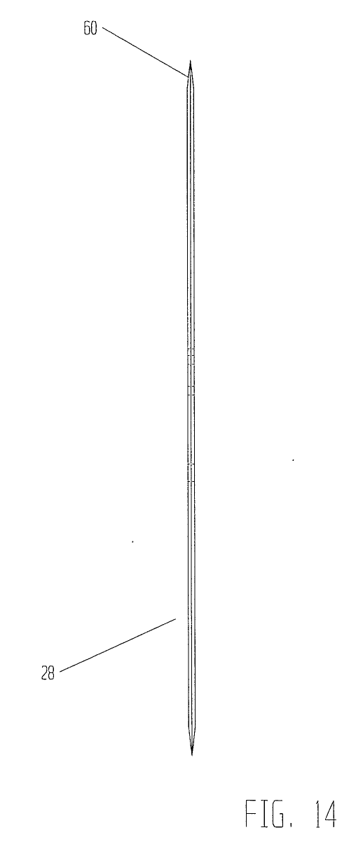

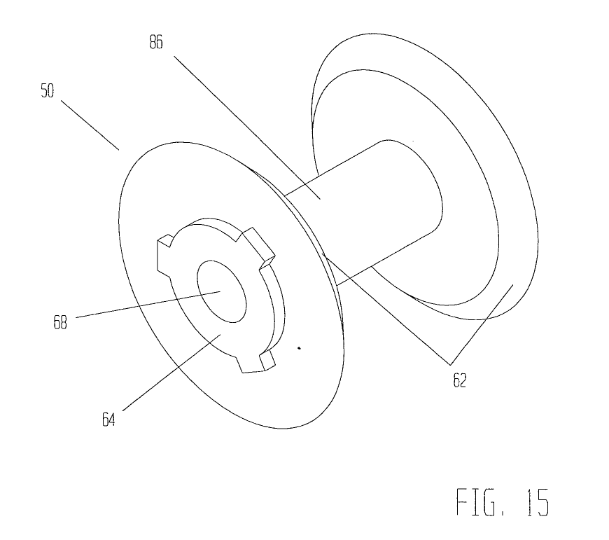

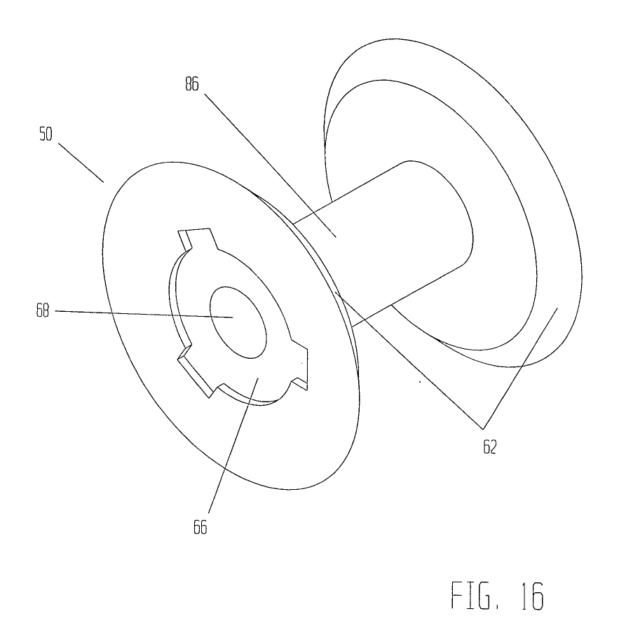

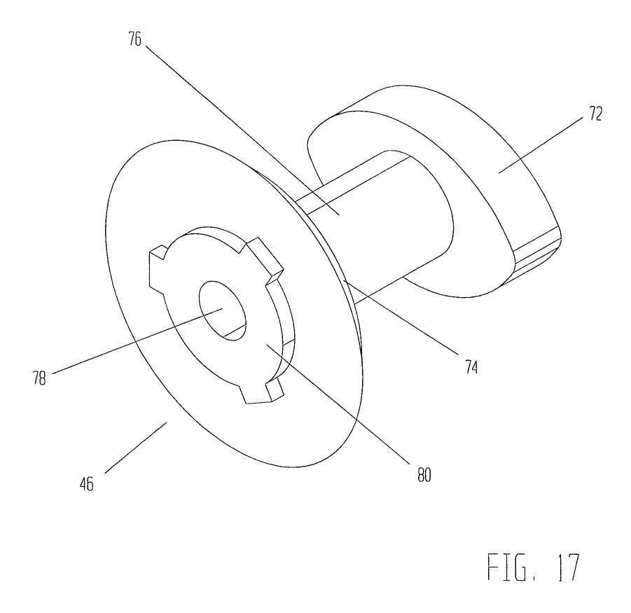

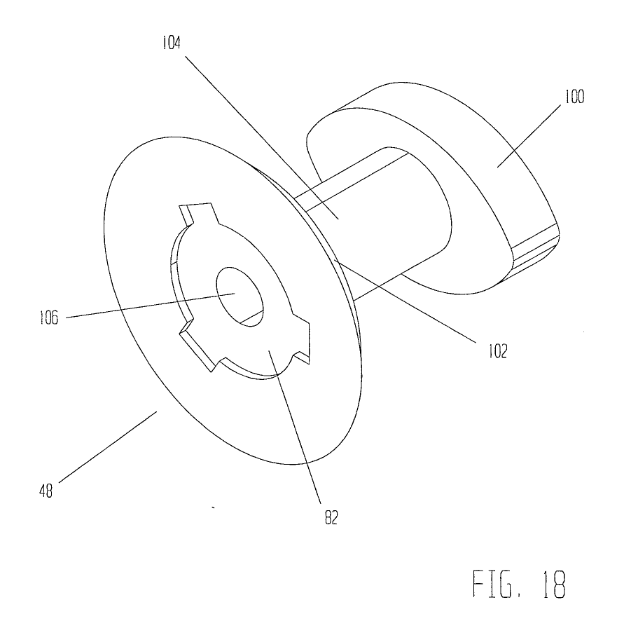

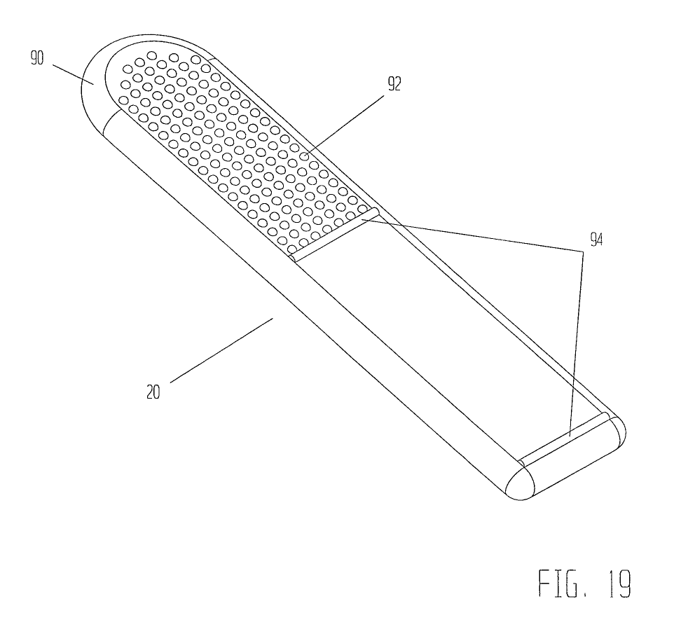

A rotary food processing knife according to a first embodiment of the present invention is depicted in FIGS. 1 through 19. While the invention will be described in detail herein below with reference to this embodiment, it should be understood that the invention is not limited to the specific constructions or configurations shown in the embodiment. Rather, one skilled in the art will appreciate that a variety of configurations may be implemented in accordance with the present invention.

Looking first to FIGS. 1, 2, 3, 4, 5, 6, 9 and 10, a rotary circular knife with detachable multi blade axis in accordance with an embodiment of the present invention is depicted generally by the designation 10. Rotary knife 10 includes a rigid trolley 12 defining a cavity 14 configured to partially cover and house a multi circular blade axis 16 thus protecting the user's hand from accidental cuts during operation, and further defining a rectangular passage 18 allocating a blade axis holder safety lock 20 which maintains a swiveling blade axis holder 22 in open or closed position for blade axis 16 insertion or retrieval. A safety cover 24 attaches to closed loop rigid handle 12 by means of built in interference tabs 26 and 96 protecting the user from accidental cuts during storage and preventing axis blade 28 damage.

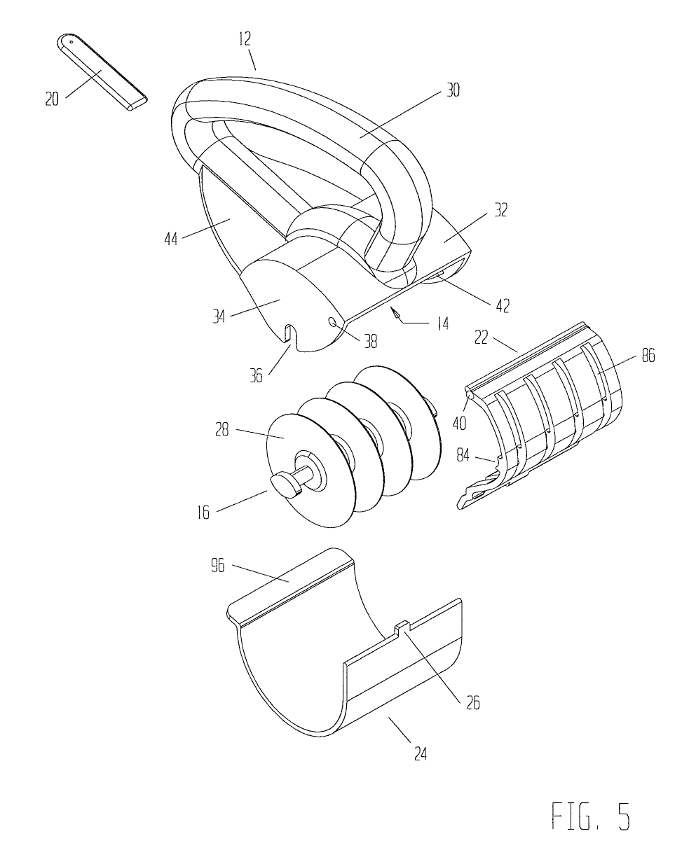

As best seen in FIGS. 5,7,8, 9 and 11, rigid trolley 12 has a closed loop handle 30 allocated right on the knife's vertical symmetry plane and over the circular blade axis 16. This design attributes permit an ergonomic fit for a left or right handed user and maximize cutting force transfer over a vertical plane from the user's hand to the knife blades 28. A curved horizontal surface 32 perpendicular to the symmetry plane extends out from the closed loop handle 30 forming a top portion of cavity 14. Vertical guards 34 are located at the ends of curved surface 32 defining side portions of cavity 14 which partially covers and houses a milti-cicular blade axis 16. Vertical guards 34 are provided with circular seat notches 36 which couple with and restrict a multi-circular blade axis 16 to a rotary motion. These same vertical guards 34 are provided with through holes 38 which mate with the blade axis holder 22 by means of interference spheres 40 thus permitting swiveling of the blade axis holder 22. Strip blocks 42 are built into vertical guards 34 to preclude the blade axis holder 22 to flex into cavity 14 during operation. Trolley 12 is also fitted with guard fins 44 to impede hand contact with circular blade axis 16 and food fragments. Further more trolley 12 includes a rectangular passage 18 allocated under closed loop handle 30 which hosts a blade axis holder safety lock 20 and restricts the blade axis safety lock movement to linear motion thus when the blade axis holder 22 is in closed position the blade axis holder safety lock 20 can be pushed forward to interfere with blade axis holder 22 impeding swiveling of the blade axis holder 22 to open position during operation or storage. This same blade axis holder safety lock 20 can be pushed backward to release the interference between blade axis holder 22 and blade axis safety lock 20 allowing the user to swivel back blade axis holder 22 to open position and retrieve or insert the circular blade axis 16 as necessary for clean up purposes. Other configurations of trolley 12 will be apparent to those skilled in the art, and are with in the scope of the present invention, such as enlarged portions to accommodate increased or decreased blade 28 quantity, diameter and thickness required by custom manufacturing for special applications.

Rigid trolley 12 may be constructed of any sturdy material capable of withstanding compression and flexure stresses that may result in permanent deformation or material failure. Preferable rigid trolley 12 is constructed of a rigid plastic material such as Acrylonitrile Butadiene Styrene (ABS), Polycarbonate and ferrous or non ferrous metals. Trolley 12 may be manufactured through injection molding, blow molding, casting or machining and composed of one or more components fastened by screws, inserts, adhesive bond, ultrasonic welding, metal welding or any combination thereof.

Looking to FIGS. 5, 11, 12, 13, 14, 15, 16, 17 and 18, circular blade axis 16 is comprised of equidistant circular blades 28, spacer bushings 50, stiffener rod 52, male locking nut 46 and female locking nut 48. Circular blades 28 are provided with an anti slip locating key way 54 geometrically defined by at through hole 56 with equiangular square notches 58 at the blade center and a double bevel perimeter edge 60. The double bevel perimeter edge 60 feature facilitates blade penetration into the meat being cut and the anti slip key way 54 assures simultaneous blade 28 movement with respect to the whole circular blade axis 16 assembly. Spacer bushings 50 are designed to equally host, locate and separate blades 28 and are provided with beveled pressure dishes 62, male anti slip locating key way 64, female anti slip locating keyway 66, cylindrical contact bar 86 and locating through cylindrical passage 68. The stiffener rod 52 is provided with and external thread 70 which integrates the core fastening means for the circular blade axis assembly. Male locking nut 46 includes an oval shaped torque application point 72, beveled pressure dish 74, cylindrical contact bar 76, threaded cavity 78 and male anti slip locating key way 80. Female locking nut 48 is provided with an oval shaped torque application point 100, beveled pressure dish 102, cylindrical contact bar 104, threaded cavity 106 and female anti slip locating key way 82.

Circular blade axis 16 integration is attained by first engaging stiffener rod 52 external threads 70 to male locking nut 46 at threaded cavity 78 and torqued to specification through oval shaped torque application point 72. Integration of circular blade axis 16 is secondly followed by matching the circular blade 28 anti slip locating key way 54 to male locating key way 80 and resting circular blade 28 on beveled pressure dish 74. Spacer bushing 50 is then inserted female anti slip locating key way 66 first to stiffener rod 52 though locating cylindrical passage 68. A second circular blade 28 is placed in position by matching the anti slip locating key way 54 to male anti slip locating key way 64 and resting circular blade 28 on beveled pressure dish 62. Spacer bushing 50 is then inserted female anti slip locating key way 66 first to stiffener rod 52 though locating cylindrical passage 68. A third circular blade 28 is placed in position by matching the anti slip locating key way 54 to male anti slip locating key way 64 and resting circular blade 28 on beveled pressure dish 62. Spacer bushing 50 is then inserted female anti slip locating key way 66 first to stiffener rod 52 though locating cylindrical passage 68. A fourth circular blade 28 is placed in position by matching the anti slip locating key way 54 to male anti slip locating key way 64 and resting circular blade 28 on beveled pressure dish 62. Female locking nut 48 is finally incorporated to circular blade axis 16 by engaging stiffener rod 52 external threads 70 to female locking nut 48 at threaded cavity 106 and torqued to specification through oval shaped torque application point 100. This design features distribute circular blades 28 in a parallel array along a symmetry axis and equidistant from each other. Pressure is exerted constantly to beveled pressure dishes 62, 74 and 102 by means of male locking nut 46 and female locking nut 48 that tension stress stiffener rod 52. This static compression force holds circular blades 28 in place and assures function of the anti slip locating key ways 54, 64, 66, 80 and 82. Male locking nut 46, spacer bushings 50 and female locking nut 48 encapsulate stiffener rod 52 which in turn prevents circular blade axis 16 to flex beyond a given distance when a maximum operating force is applied to it. This multi bladed configuration enables the user to perform simultaneous cuts per stroke thus decreasing processing time.

Male locking nut 46, spacer bushings 50 and female locking nut 48 may be glued or screwed to each other, or other fastening methods known in the art may be employed. Alternatively circular blade axis 16 may be formed as a unitary piece such as by casting, machining or molding. Other materials or fastening methods will be apparent to those skilled in the art and are within the scope of the present invention.

Preferably, circular blade 28 is made from a food grade metal such as stainless steel or titanium. Most preferably, circular blade 28 is made from 18-8, 316 or 304 24 gauge stainless steel. Stiffener rod 52 is preferably made from a rigid tubular metal such as steel, stainless steel, aluminum, or titanium, having a diameter of approximately 3/16 inches. Most preferably, stiffener rod 52 is made from solid tubular steel having a mayor diameter of 0.190 inches and includes a 10-24 UNC external thread 70 having a tension stress area of 0.0175 square inches. Stiffener rod 52 is designed such that it has sufficient tensile strength to withstand flexure stresses and will not flex beyond the design allowable dynamic length. Male locking nut 46, spacer bushing 50 and female locking nut 48 are made from a rigid polymeric material, preferably a moldable plastic. More preferably, male locking nut 46, spacer bushing 50 and female locking nut 48 are made of a thermoplastic such as nylon, having sufficient tensile strength and abrasion resistance to adequately sustain the tension, compression, flexure and torsion stresses. A suitable material for this purpose is nylon 66, such as Dupont's Zytel® brand nylon resin. Other configurations will be apparent to those skilled in the art, and are within the scope of the present invention, such as increased diameter stiffener rod 52 with corresponding thread provisions, metal male locking nut 46, metal spacer bushing 50, metal female locking nut 48 or hollow and/or solid single piece circular blade axis manufactured by metal casting or machining processes.

Looking to FIGS. 5, 7, 8, 9, 11, 12, 16, 17, 18 and 19, generally circular blade axis holder 22 is comprised of a rigid material, and formed to conform in shape to rigid trolley 12 in the area of curved horizontal surface 32 and vertical guards 34. Circular blade axis holder 22 is provided with interference spheres 40 which mate with vertical guards 34 at through holes 38 which act as a hinge and permit swiveling of the blade axis holder 22 to place it on open or closed position for circular blade axis 16 insertion or retrieval. Circular blade axis holder 22 is fitted with semicircular rests 84 which provide support to the circular blade axis 16 at male locking nut 46, spacer bushing 50 and female locking nut 48 on a section of cylindrical contact bar 76, 86 and cylindrical contact bar 104 outer surfaces when circular blade axis 16 is inserted and circular blade axis holder 22 is in closed position. Circular blade axis holder 22 is provided with through openings 86 that preclude large food fragments from entering cavity 14 of rigid trolley 12 during operation and include sufficient groove width such that they do not interfere with circular blade axis 16 rotary movement and sufficient length to provide clearance of circular blade 28 outer diameter periphery for circular blade axis retrieval. A built in interference tab 88 is provided to lock circular blade axis holder 22 in close position by sliding over a portion of blade axis holder safety lock 20.

Blade axis holder safety lock 20 is comprised of a rectangular shaped rigid material with round edges 90, grip spheres 92 and displacement limit barriers 94. Grip spheres 92 provide better user-component traction and allow easier displacement of the circular axis holder lock 20. Displacement limit barriers 94 restrict linear movement of blade axis holder safety lock 20 to a predetermined design stroke by interfering with rectangular passage 18 on full extension and full retraction.

Safety cover 24 includes a semicircular shaped rigid material with built in interference tabs 26 and 96. Interference tab 26 snaps into rigid handle 12 at insertion gap 98 created by horizontal curved surface 32 and circular blade axis holder 22. Interference tab 96 snaps into rigid handle 12 at rectangular passage 18. Safety cover 24 protects the user from accidental cuts during storage and circular blade axis 16 from damage.

Preferably, circular blade axis holder 22, circular blade axis holder lock 20 and safety cover 24 are constructed of a rigid plastic material. This material must have a tensile strength capable of withstanding the flexure stresses to which the components are exposed with the provided geometry. Suitable materials for this purpose are Acrylonitrile Butadiene Styrene (ABS), Polycarbonate and ferrous or non ferrous metals. Circular blade axis holder 22, circular blade axis holder lock 20 and safety cover 24 may be manufactured through injection molding, blow molding, casting or machining. Other materials, configurations or fastening methods will be apparent to those skilled in the art, and are within the scope of the present invention.

The knife handle provides a strong protective trolley, while also providing maximum vertical force transfer to cutting circular blade axis. The blade axis provides equidistant circular blades that rotate freely clockwise or counter clock wise. The blade axis holder precludes food fragments from entering the handle cavity. The axis holder lock provides assured positive fastening means for the blade axis holder and the safety cover ensures user and blade protection during storage. Thus, the rotating food-processing knife with detachable multi blade axis having a rigid handle, circular blade axis, circular blade axis holder, safety lock and safety cover of the present invention provides improved comfort to slit or chop large amounts of hot of the grill meat in a rapid and effortless manner, enables the user to perform simultaneous cuts per stroke, eliminates the need for an extra utensil such as a fork to hold the grilled meat when processing and maximizes force transfer to decrease premature user fatigue and unnecessary burden.

From the foregoing it will be seen that this invention is one well adapted to attain all ends and objectives herein-above set forth, together with the advantages which are obvious and which are inherent to the invention.

Since many possible embodiments may be made of the invention without departing from the scope thereof, it is to be understood that all matters herein set forth or shown in the accompanying drawings are to be interpreted as illustrative, and not in a limiting sense.

The terms “substantially”, “approximately”, and “relatively” as used herein may be applied to modify any quantitative representation which could permissibly vary without resulting in a change in the basic function to which it is related. For example, the spacing between blades 28, blade 28 diameter, blade 28 quantities and stiffener rod 52 diameter disclosed herein as being approximately 0.750, 2.350, 4 and 0.190 inches respectively may permissibly vary from this dimension and still be with in the scope of the invention if the variance does not materially alter the capability of the invention. Likewise, the variance from any quantitative representation, such as proximate or adjacent as used herein, is permissible if the variance does not materially alter the capability of the invention.

While specific embodiments have been shown and discussed, various modifications may of course be made, and the invention is not limited to the specific forms or arrangements of parts and steps describe herein, except insofar as such limitations are included in the following claims. Further, it will be understood that certain features and sub combinations are of utility and may be employed without reference to other features and sub

1. A rotating food processing knife comprising:
a rigid trolley, defining a cavity configured to partially cover and house a multi circular blade axis and having horizontal and vertical portions shaped to protect the user's hand from accidental cuts during operation, said shell configured with a closed loop handle allocated right on the knife's vertical symmetry plane and over the circular blade axis permitting an ergonomic fit for a left or right handed user and maximize cutting force transfer over a vertical plane from the user's hand to the knife blades.
a circular blade axis with equidistant parallel circular blades to enable the user to perform simultaneous cuts per stroke in a bidirectional motion when engaged to said trolley.
a circular blade axis holder attached to said trolley by interference sphere means thus forming a pivot axis that acts as a hinge, allowing the circular blade axis holder to swivel to an open or closed position and permitting insertion or retrieval of the circular blade axis to the rigid trolley for clean up purposes after operation.
a blade axis holder safety lock allocated on said trolley and provided with interference securing means such that it precludes the circular blade axis holder from accidentally opening and releasing the circular blade axis.
a safety cover attached to rigid trolley such that said cover protects the user from accidental cuts during storage handling and circular blades from damage, when said
safety cover is detached circular blades are partially exposed for knife operation.

2. The rotating food processing knife of claim 1, wherein said
rigid trolley comprises circular seat notches which couple with and restrict the multi circular blade axis to rotary motion.

3. The rotating food processing knife of claim 1, wherein said rigid trolley comprises through holes which mate with the blade axis holder by means of interference spheres thus permitting swiveling of the blade axis holder.

4. The rotating food processing knife of claim 1, wherein said rigid trolley comprises a rectangular passage allocated under closed loop handle which hosts the blade axis holder safety lock and restricts the blade axis safety lock movement to linear motion.

5. The rotating food processing knife of claim 1, wherein said rigid trolley comprises a plastic material.

6. The rotating food processing knife of claim 5, wherein said plastic material comprises ABS.

7. The rotating food processing knife of claim 1, wherein said circular blade axis comprises an encapsulated stiffener rod which prevents circular blade axis to flex beyond a given design distance when a maximum operating force is applied to it.

8. The rotating food processing knife of claim 7, wherein said encapsulated stiffener rod comprises a threaded rod.

9. The rotating food processing knife of claim 8, wherein said encapsulated stiffener rod comprises a steel material.

10. The rotating food processing knife of claim 9, wherein said steel material comprises stainless steel.

11. The rotating food processing knife of claim 1, wherein said circular blade axis comprises spacer bushings that keep circular blades in equidistant parallel array.

12. The rotating food processing knife of claim 11, wherein said spacer bushings comprise an anti slip self locating key way that assures blade concentricity and simultaneous circular blade rotation.

13. The rotating food processing knife of claim 11, where in said spacer bushings are comprised of beveled pressure dishes that transfer compression force to circular blades and holds them in place assuring function of the anti slip self locating key ways.

14. The rotating food processing knife of claim 11, wherein said spacer bushings are comprised of locating through cylindrical passages that position and encapsulate stiffener rod.

15. The rotating food processing knife of claim 11, wherein said spacer bushings are comprised of a rigid polymeric material.

16. The rotating food processing knife of claim 15, wherein said rigid polymeric material is nylon 66.

17. The rotating food processing knife of claim 1, wherein circular blade axis comprises a male locking nut to constantly exert pressure to circular blades thus keeping them in place and precluding rotary motion with respect to each other.

18. The rotating food processing knife of claim 17, wherein said male locking nut comprises an anti slip self locating key way that assures blade concentricity and simultaneous circular blade rotation.

19. The rotating food processing knife of claim 17, wherein said male locking nut comprises a beveled pressure dish that transfers compression force to circular blades and holds them in place assuring function of the anti slip self locating key ways.

20. The rotating food processing knife of claim 17, where said male locking nut comprises an oval shaped torque application point.

21. The rotating food processing knife of claim 17, wherein said male locking nut comprises an internal threaded cavity to engage to threaded stiffener rod and provide compression force to circular blade axis assembly.

22. The rotating food processing knife of claim 17, wherein said male locking nut comprises a cylindrical contact bar that couple with circular seat notch of rigid trolley allowing the circular blade axis to rotate freely in both clockwise and counter clockwise directions.

23. The rotating food processing knife of claim 17, wherein said male locking nut is comprised of a rigid polymeric material.

24. The rotating food processing knife of claim 23, wherein said rigid polymeric material is nylon 66.

25. The rotating food processing knife of claim 1, wherein circular blade axis comprises a female locking nut to constantly exert pressure to circular blades thus keeping them in place and precluding rotary motion with respect to each other.

26. The rotating food processing knife of claim 25, wherein said female locking nut comprises a beveled pressure dish that transfers compression force to circular blades and holds them in place assuring function of the locating anti slip key ways.

27. The rotating food processing knife of claim 25, where said female locking nut comprises an oval shaped torque application point.

28. The rotating food processing knife of claim 25, wherein said female locking nut comprises an internal threaded cavity to engage to threaded stiffener rod and provide compression force to circular blade axis assembly.

29. The rotating food processing knife of claim 25, wherein said female locking nut comprises a cylindrical contact bar that couples with circular seat notch of rigid trolley allowing the circular blade axis to rotate freely in both clockwise and counter clockwise directions.

30. The rotating food processing knife of claim 25, wherein said female locking nut is comprised of a rigid polymeric material.

31. The rotating food processing knife of claim 30, wherein said rigid polymeric material is nylon 66.

32. The rotating food processing knife of claim 1, wherein said circular blade axis comprises circular double beveled blades.

33. The rotating food processing knife of claim 32, wherein said circular blades comprise an self locating anti slip key way that assures simultaneous circular blade rotation and keep blades in position with respect to each other.

34. The rotating food processing knife of claim 32, wherein said circular blades comprise a steel material.

35. The rotating food processing knife of claim 34, wherein said steel material comprises stainless steel.

36. The rotating food processing knife of claim 1, wherein said circular blade axis holder comprises a plurality of openings to partially expose the rotating axis circular blades and precludes small food fragments from entering the rigid trolley cavity.

37. The rotating food processing knife of claim 1, wherein said circular blade axis holder comprises a plastic material.

38. The rotating food processing knife of claim 37, wherein plastic material comprises ABS.

39. The rotating food processing knife of claim 1, wherein said circular blade axis holder safety lock comprises stroke limit barrier to fully extend or fully retract the safety lock to a locked or not locked position.

40. The rotating food processing knife of claim 1, wherein said circular blade axis holder safety lock comprises a plastic material.

41. The rotating food processing knife of claim 40, wherein said plastic material comprises ABS.

42. The rotating food processing knife of claim 1 wherein said circular blade axis safety cover comprises a plastic material.

43. The rotating food processing knife of claim 42 wherein said material comprises ABS.
